(19) United States
(12) Patent Application Publication
(10) Pub. No.: US 2016/0210672 A1
(43) Pub. Date: Jul. 21, 2016

(54) SYSTEM, METHOD AND RECORDING MEDIUM FOR ADVERTISING USING OPEN COMMERCIAL PLATFORM

(71) Applicant: NAVER Corporation, Seongnam-si (KR)

(72) Inventors: Jaehyeon Choi, Seongnam-si (KR); Jinsu Kim, Seongnam-si (KR); Sung Hun Yun, Seongnam-si (KR); Sang Ho Lee, Seongnam-si (KR)

(21) Appl. No.: 15/001,083

(22) Filed: Jan. 19, 2016

(30) Foreign Application Priority Data
Jan. 21, 2015 (KR) 10-2015-0009841

(51) Int. Cl. G06Q 30/02; G06F 17/30

(52) U.S. Cl. CPC G06Q 30/0277; G06F 17/30598; G06Q 30/0275; G06Q 30/0274

(57) ABSTRACT

Provided is system, method, and non-transitory computer-readable medium for advertising using an open commercial platform. An advertisement providing method may include generating a service channel for each advertiser, receiving content generated by a creator from a creator terminal and registering the received content, and displaying specific content approved by an advertiser among contents as advertising content of the advertiser. The registering may include registering the content to the service channel.

### CROSS-REFERENCE TO RELATED APPLICATION

This application claims priority from and the benefit of Korean Patent Application No. 10-2015-0009841, filed on Jan. 21, 2015 in the Korean Intellectual Property Office (KIPO), the disclosure of which is incorporated herein in its entirety by reference.

### BACKGROUND

1. Field

Various exemplary embodiments disclosed herein relate to a content platform for providing content in a form of user generated content (UGC).

2. Description of the Background

In the recent times, an information search over a communication network has been generalized with rapid developments in the communication network such as the Internet, etc. A website refers to an aggregated body storing information in a web server. In detail, the website indicates an aggregated body that has stored information in the web server that provides information to a user at any time when the user requests the information.

Websites are configured as a set of webpages that are created using HyperText Markup Language (HTML) and each webpage includes a variety of contents, for example, advertisements including text and images, articles, etc.

With the recent rapid technology distribution, mobile-related markets are expanding, and the scale of mobile advertisement markets are also quickly increasing. Video contents are being used for a portion of the advertisements currently being provided. However, many of them are image-based advertisements, such as banners of web advertisement markets and the like.

### SUMMARY

Some exemplary embodiments provide a method, system, and/or non-transitory medium that may register content through an open commercial platform.

Some exemplary embodiments also provide a method, system, and/or non-transitory medium that enables a consumer to directly generate content, to provide the generated content as an advertisement of a company, and to share profits according to the advertising effect.

Some exemplary embodiments also provide a method, system, and/or non-transitory medium that may operate an advertisement generated by a consumer to be viral to earned media through an open commercial platform.

According to at least one exemplary embodiment, there is provided an advertisement providing method executed on a computer including at least one processor, the method including generating a service channel for each advertiser, receiving content generated by a creator from a creator terminal and registering the received content, and displaying specific content approved by an advertiser from among a plurality of contents as advertising content of the advertiser. The registering may include registering the content to the service channel.

The displaying may include displaying specific content approved by the advertiser among the contents registered to the service channel, through the service channel.

The displaying may include providing a list of contents corresponding to a search request from the advertiser among the registered contents, and displaying specific content approved by the advertiser from the list of contents as the advertising content.

The displaying may include simultaneously registering and displaying the content and classifying the content based on information set by the creator and displaying the classified content.

The displaying may include providing a list of contents corresponding to a search request from the advertiser among the registered contents and public contents registered to an external platform or display media, and displaying specific content approved by the advertiser from the list of contents as the advertising content.

The displaying may include displaying the specific content as advertising content of an advertiser that has previously approved the specific content.

The displaying may include displaying the specific content as advertising content of an advertiser selected through bidding.

The advertisement providing method may further include sharing the advertising content through at least one display media.

The sharing may include sharing, in response to a user request, the advertising content through at least one of a social networking service (SNS), an Internet bulletin board, a messenger, a mail service, and a message service selected by a user.

The advertisement providing method may further include calculating the cost of advertising based on at least one of display counts of the advertising content, user view counts, and share counts, and charging the advertiser the calculated advertising cost.

The advertisement providing method may further include distributing profit earned in association with the advertising content to the creator that generated the specific content.

According to at least one exemplary embodiment, there is provided a non-transitory computer readable medium including computer readable instructions to control a computer system to provide an advertisement, wherein the computer readable instructions are configured to generate a service channel for each advertiser, receive content generated by a creator from a creator terminal and register the received content to the service channel, display specific content approved by an advertiser from among a plurality of contents as advertising content of the advertiser, and distribute profit earned in association with the advertising content to the creator that generated the specific content.

According to at least one exemplary embodiment, there is provided an advertisement providing system including a generator configured to generate a service channel for each advertiser, a registerer configured to receive content generated by a creator from a creator terminal and to register the received content, and a provider configured to display specific content approved by an advertiser from among a plurality of contents as advertising content of the advertiser. The registerer may be further configured to register the content to the service channel.

The provider may be further configured to display specific content registered by the advertiser among the contents registered to the service channel, through the service channel.

The provider may be further configured to provide a list of contents corresponding to a search request from the advertiser among the registered contents, and to display specific content approved by the advertiser from the list of contents as the advertising content.

The provider may be further configured to display the specific content as advertising content of an advertiser that has previously approved the specific content.

The provider may be further configured to display the specific content as advertising content of an advertiser selected through bidding.

The advertisement providing system may further include a sharer configured to share, in response to a user request, the advertising content through at least one of a social networking service (SNS), an Internet bulletin board, a messenger service, a mail service, and a message service selected by a user.

The advertisement providing system may further include a settler configured to calculate advertising cost based on at least one of display counts of the advertising content, user view counts, and share counts, and to charge the advertiser the calculated advertising cost.

The advertisement providing system may further include a distributor configured to distribute profit earned in association with the advertising content to the creator that generated the specific content.

It is to be understood that both the foregoing general description and the following detailed description are explanatory and are intended to provide further explanation of the exemplary embodiments as claimed.

### Effect

According to at least one exemplary embodiment, it is possible to configure a new advertisement model that enables a consumer that generated content and an advertiser to mutually develop by circulating the consumer generated content as an advertisement of a company through an open commercial platform.

Also, according to at least one exemplary embodiment, since a consumer may directly generate an advertisement of a company and may share profits according to the advertising effect, it is possible to induce the consumer to take the initiative to generate content and provide the content in a viral manner.

Also, according to at least one exemplary embodiment, since an advertiser may utilize lean forward advertising in which an advertisement itself instead of an advertisement disguised as content is content, it is possible to maximize the advertising effect.

Also, according to at least one exemplary embodiment, an advertising company may secure a variety of advertising contents from many consumers and may also secure media competitiveness by providing a further friendly advertisement to a user.

Also, according to at least one exemplary embodiment, a user may not have an antipathy against an advertisement of a company by consuming not existing one-sided and repetitive advertisements but contents generated by consumers equivalent to the user.

### BRIEF DESCRIPTION OF THE DRAWINGS

The foregoing and other features of the exemplary embodiments will be apparent from the more particular description of non-limiting exemplary embodiments, as illustrated in the accompanying drawings in which like reference characters refer to like parts throughout the different views. The drawings are not necessarily to scale, emphasis instead being placed upon illustrating principles of inventive concepts. In the drawings:

FIG. 1 illustrates an example of an advertisement providing environment according to at least one exemplary embodiment.

FIG. 2 is a block diagram illustrating a configuration of an advertisement providing system according to at least one exemplary embodiment.

FIGS. 3 and 4 are flowcharts illustrating an example of an advertisement providing method using an open commercial platform according to at least one exemplary embodiment.

FIGS. 5 through 8 illustrate examples of a service screen for uploading advertising content to be viral according to at least one exemplary embodiment.

FIGS. 9 and 10 are flowcharts illustrating another example of an advertisement providing method using an open commercial platform according to at least one exemplary embodiment.

FIG. 11 is a block diagram illustrating a configuration of a computer system according to at least one exemplary embodiment.

### DETAILED DESCRIPTION

Various exemplary embodiments will now be described more fully with reference to the accompanying drawings, in which some exemplary embodiments are shown. Exemplary embodiments, may, however, be embodied in many different forms and should not be construed as being limited to the embodiments set forth herein. Rather, these exemplary embodiments are provided so that this disclosure will be thorough and complete, and will fully convey the scope of the exemplary embodiments to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

The terminology used herein is for the purpose of describing particular embodiments only and is not intended to be limiting of the exemplary embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which the exemplary embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, various exemplary embodiments will be described with reference to the accompanying drawings.

At least one exemplary embodiment relates to an advertising platform that may register and circulate advertising content in the form of user generated content (UGC).

In general, advertisements contain one-sided messages of companies and many of them are displayed together with other contents. That is, since many advertisements are displayed in a form of disguised contents, the fatigue and antipathy of users against such advertisements is increasing.

Proposed herein is an open commercial platform that may advertise content generated by a consumer so that the consumer may directly contain a message in an advertisement of a company, and that enables the consumer generated content to function as the advertisement of the company and at the same time, function as communication between consumers.

The term “advertising content” used herein refers, for example, to multimedia content in the form of UGC, and may indicate any type of contents in which a consumer has applied a specific theme, message, etc. Additionally, the advertising content may indicate any type of contents that are generated for advertising and promoting a specific company, brand, product, etc. Such advertising content may be defined as consumer generated content (CGC).

Further, the term “consumer” may indicate any entity that, including general users, generates advertising content. Hereinafter, the term “consumer” is also referred to as a creator.

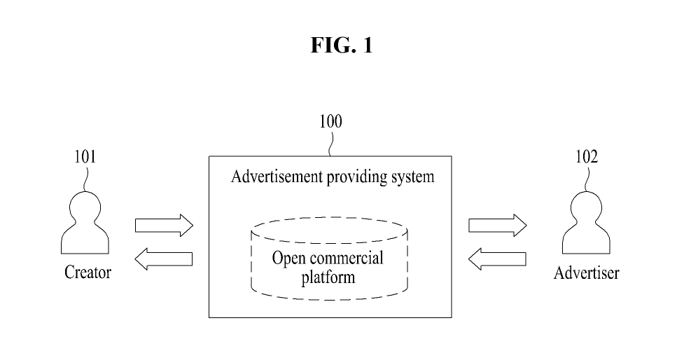

FIG. 1 illustrates an example of an advertisement providing environment according to an exemplary embodiment. FIG. 1 illustrates a creator 101, an advertisement providing system 100, and an advertiser 102. In FIG. 1, arrow indicators indicate that data may be transmitted and received among the creator 101, the advertisement providing system 100, and the advertiser 102 over a wired and/or wireless network.

The creator 101 and the advertiser 102 may refer to any type of terminal devices, for example, a personal computer (PC), a laptop, a smartphone, a tablet, a smart device, a wearable computer, a personal digital assistant (PDA), etc., which are being substantially used by the creator 101 and the advertiser 102, capable of connecting to a website/mobile site associated with the advertisement providing system 100 and/or installing and executing a service exclusive application (e.g., a computer program, a web applet, a smart device app, a widget, etc.). Here, terminal devices used by the creator 101 and the advertiser 102 may perform the overall service operation, such as service screen configuration, data input, data transmission and reception, data storage, or the like, under the control of the website/mobile site or the exclusive application.

The creator 101 may generate advertising content associated with a specific theme or message, a company, a brand, a product, and the like, and may provide the generated advertising content to the advertisement providing system 100. The advertiser 102 may select and utilize the advertising content generated by the creator 101 as an advertisement of the advertiser 102 through the advertisement providing system 100.

The advertisement providing system 100 serves as an advertising platform that provides advertising content to a service user. In particular, the advertisement providing system 100 may provide the advertisement content generated by the creator 101 to the advertiser 102 and may display the advertising content of the creator 101 selected by the advertiser 102 as a formal advertisement of the advertiser 102. Further, the advertisement providing system 100 may readily share the advertising content selected by the advertiser 102 through earned media, for example, an external social networking service (SNS), a blog, a café, and the like, in response to a request from the creator 101 or a user. Advertising profit earned in association with the advertising content may be distributed to the creator 101 that generated the advertising content.

That is, the advertisement providing system 100 provides an open commercial platform that relays the advertising content between the creator 101 and the advertiser 102. Here, the advertisement providing system 100 may be configured to relay advertising content registered to a platform of the advertisement providing system 100 and may also be configured to relay the registered advertising to another external platform or display media interaction with the another external platform or display media, which is an exemplary embodiment of open-type advertising content relay. The advertisement providing system 100 may be configured as an internal system that is directly operated by a provider having proposed the open commercial platform or may be configured as a system that is operated by a third party service provider.

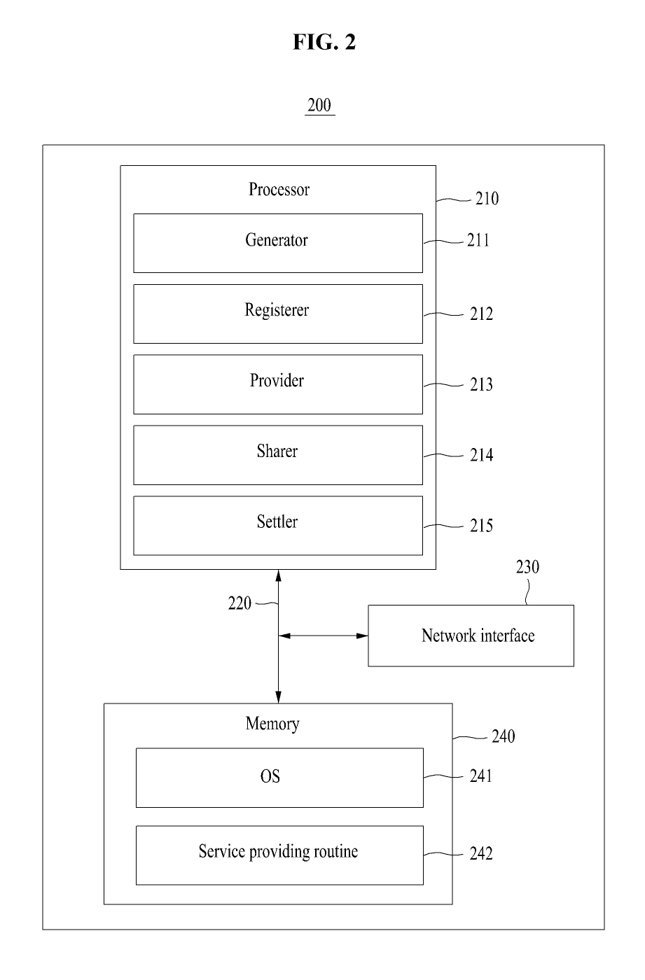

FIG. 2 is a block diagram illustrating a configuration of an advertisement providing system according to an exemplary embodiment.

Referring to FIG. 2, the advertisement providing system 200 may include one or more computing devices, such as a server, that include at least one processor 210, a bus 220, a network interface 230, a memory 240, etc. The memory 240 may include an operating system (OS) 241 and a service providing routine 242. The processor 210 may include computer readable instructions for specially programming the processor 210 as a generator 211, a registerer 212, a provider 213, a sharer 214, and/or a settler 215. According to other exemplary embodiments, the advertisement providing system 200 may include a greater or lesser number of constituent elements than the number of constituent elements shown in FIG. 2.

The memory 240 may include a permanent mass storage device, such as a random access memory (RAM), a read only memory (ROM), a disc drive, a solid state drive, an optical drive, etc., as a computer-readable storage medium. Also, program codes (e.g., computer readable instructions) for the OS 241, the service providing routine 242, the computer readable instructions associated with the generator 211, the registerer 212, the provider 213, the sharer 214, and/or the settler 215, etc., may be stored in the memory 240. Such software constituent elements may be loaded from another computer-readable storage medium separate from the memory 240 using a drive mechanism (not shown). The other computer-readable storage medium may include, for example, a floppy drive, a disc, a tape, a DVD/CD-ROM drive, a memory card, etc. Software constituent elements may be loaded to the memory 240 through the network interface 230 instead of, or in addition to, the computer-readable storage medium.

The bus 220 enables communication and data transmission between the constituent elements of the advertisement providing system 200. The bus 220 may be configured using a high-speed serial bus, a parallel bus, a storage area network (SAN), and/or another appropriate communication technology.

The network interface 230 may be a computer hardware constituent element for connecting the advertisement providing system 200 to the computer network. The network interface 230 may connect the advertisement providing system 200 to the computer network through a wireless and/or wired connection.

The processor 210 may be configured to process computer-readable instructions of a computer program by performing basic arithmetic operations, logic operations, and input/output operations of the advertisement providing system 200. The computer-readable instructions may be provided from the memory 240 and/or the network interface 230 to the processor 210 through the bus 220. The processor 210 may be configured to execute program codes for the generator 211, the registerer 212, the provider 213, the sharer 214, and/or the settler 215. The program codes may be stored in a storage device such as the memory 240.

When executed by a processor, such as the processor 210, the computer-readable instructions associated with the generator 211, the registerer 212, the provider 213, the sharer 214, and/or the settler 215 transform the processor 210 into a special purpose processor configured to perform an advertisement providing method according to some exemplary embodiments. The processor 210 may be also be configured by omitting some components disclosed above, by further including a component not illustrated herein, or by combining two or more components together, based on the advertisement providing method.

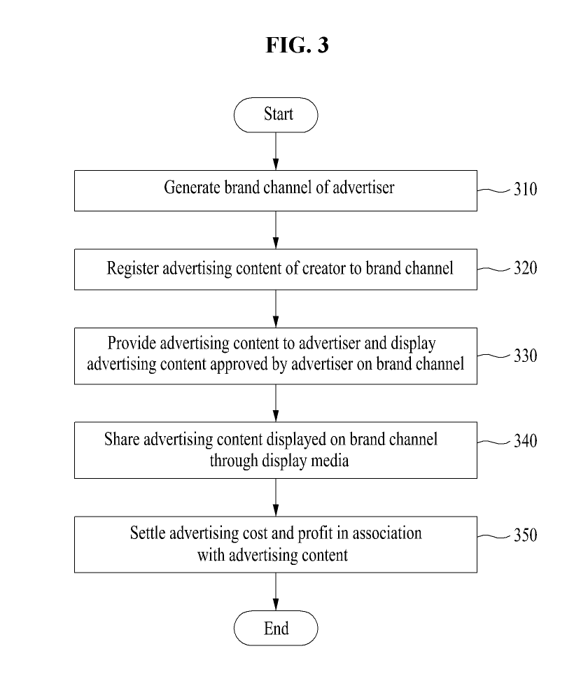

FIG. 3 is a flowchart illustrating an advertisement providing method using an open commercial platform according to an exemplary embodiment.

In operation 310, the generator 211 generates a brand channel associated with an advertiser as an open commercial space of the advertiser. That is, when the advertiser requests an open commercial platform for an account, the generator 211 may generate an individual brand channel for each advertiser in response to an approval for the account request.

In operation 320, the registerer 212 may register advertising content generated by a creator to the brand channel of the advertiser. For example, when the creator uploads the generated advertising content by connecting to a specific brand channel on the open commercial platform, the registerer 212 may register the uploaded advertising content to the specific brand channel. That is, through a brand channel associated with an account of each advertiser, the registerer 212 may collect advertising content associated with a company, a brand, a product, etc., of a corresponding advertiser, generated by a creator. In this example, when the advertising content is registered to the open commercial platform, the advertising content is not immediately displayed and is maintained in a not-display state, such as a blind processing or the like, until an advertiser of a registered brand channel approves the advertising content.

In operation 330, the provider 213 may provide the advertiser with a notification about the advertising content registered to the brand channel and may display the advertising content once it has been approved by the advertiser on the brand channel. Here, the provider 213 may notify the advertiser about registration of the advertising content using a mail service, an SNS service, a message service, etc., in addition to the brand channel. The provider 213 may receive an approval intent of an advertiser for each advertising content registered to a brand channel of the advertiser and may display the approved advertising content on a list of contents on the brand channel of the advertiser, so that users (including general users, creators, and advertisers) of the open commercial platform may view the approved content. That is, only advertising content approved by the advertiser from among the advertising contents registered by creators may be displayed on a corresponding brand channel and be viewed and available by users.

In operation 340, the sharer 214 may share the advertising content displayed on the brand channel of the advertiser through display media in response to a user request. Here, the sharer 214 may provide a sharing function on an SNS, an Internet bulletin board (blogs, cafes, etc.), a messenger, a mail, a message, etc., so that a user may readily share advertising content displayed on a specific brand channel in a viral manner.

In operation 350, the settler 215 settles the advertising cost and profit based on performance occurring within the open commercial platform and performance occurring on another display media through sharing, in association with the advertising content displayed on the brand channel of the advertiser. The performance of the advertising content may include display counts, user view counts, share counts using display media, etc. The settler 215 may calculate the advertising cost based on viral performance of the advertising content approved by the advertiser, may charge the advertiser the calculated advertising cost, and may distribute a portion of advertising profit received from the advertiser to the creator that created the advertising content.

In detail, the settler 215 may calculate the advertising cost based on viral performance associated with the advertising content that has been approved by the advertiser. Here, the settler 215 may verify an advertisement display state in real time by tracking display media used for sharing the advertising content, in order to measure the viral performance of the advertising content. That is, the viral performance may be ascertained including display media through sharing with the platform on which the advertising content is displayed. Further, the viral performance may include content display counts/reference counts within the platform and aggressive user interactions (e.g., like, comments, recommendations, etc.) occurring on the display media. The viral performance may be measured by applying a single measurement method or by combining two or more measurement methods. For example, the settler 215 may calculate a pre-set amount per total reference counts as the advertising cost. In this instance, the settler 215 may perform upward regulation or downward regulation of the average payment according to an increase in reference counts. For example, the settler 215 may adjust the advertising cost as 10 won per reference up to 100,000 counts, as 15 won per reference between 100,000 and 200,000 counts, and as 30 won per reference over 200,000 counts. In an example in which the total reference counts reaches a pre-set value, the settler 215 may calculate the advertising cost as 1 million won when the total reference counts reaches 100,000 counts and may calculate the advertising cost as 2 million won when the total reference counts reaches 200,000 counts. Likewise, the settler 215 may perform upward or downward regulation of the average payment per reference. For example, the settler 215 may adjust advertising cost to be 1 million won when the total reference counts reaches 100,000 counts and to be 1 won per reference, and may adjust the advertising cost to be 3 million won when the total reference counts reaches 200,000 counts and to be 1.5 won per reference. As another example, the settler 215 may calculate the advertising cost using a cost per view (CPV) method. In this example, the settler 215 may determine a valid view with respect to the advertising content and may calculate the advertising cost with respect to a view that is determined as a valid reference. For example, when the advertising content is played back for 15 or more seconds, it may be determined as a valid reference count and the settler 215 may calculate a pre-set amount per valid reference as the advertising cost.

A viral performance operation period of the advertising content may be administered based on a desired or alternatively predetermined period, for example, weekly, monthly, etc., and may also be operated until a pre-set advertising cost has been exhausted (i.e., by pre-setting a maximum advertising cost). In a view from the same context, the maximum advertising cost payable by an advertiser may be limited. For example, the maximum advertising cost may be limited to 100 million won during a specific period. Further, when a viral performance is very low, operation resources may be relatively excessively used compared to the advertising effect and thus, a minimum performance criterion may be set. For example, the advertising cost may be paid for advertising content referred to a minimum of 10,000 counts or more.

The aforementioned measurement of the viral performance (e.g., display period/display counts and reference counts per media, etc.), the charge of the advertising cost, the distribution of the advertising profit, etc., may be managed together with the registration and operation of the advertising content within the open commercial platform that is within a single system, or it may be configured and thereby operated as an admin system that is separate from the system for registering and operating the advertising content.

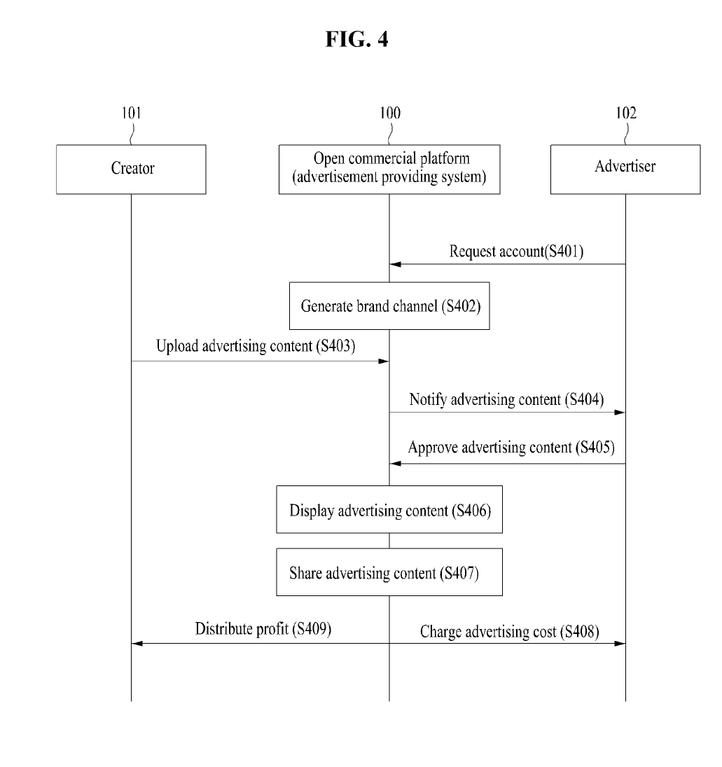

FIG. 4 illustrates a service flow according to the advertisement providing method of FIG. 3.

Referring to FIG. 4, in operation S401, an advertiser 102 requests an open commercial platform 100 for a separate account. Here, the open commercial platform 100 may correspond to the advertisement providing system 100 of FIG. 1. When a platform operator approves the account request, a brand channel of the advertiser 102 is generated at the open commercial platform in operation 5402.

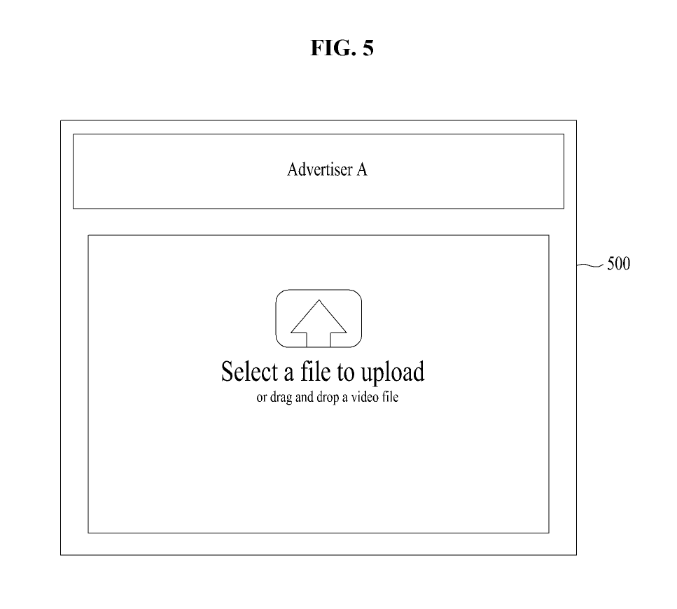

When generating advertising content in the open commercial platform 100, a creator 101 retrieves the brand channel of the advertiser 102 targeted by the creator 101 and uploads the advertising content to the brand channel in operation 5403. For example, referring to FIG. 5, when an advertiser A generates a brand channel in the open commercial platform 100, a service page 500 for an open commercial of the advertiser A is allocated to the service page 500 and the creator 101 may connect to the brand channel of the advertiser A and may upload advertising content created in association with the advertiser A through the service page 500 of the brand channel.

When the advertising content is registered by the creator 101, the registration of the advertising content may be notified to the advertiser 102 using a mail service, an SNS service, etc., instead of, or in addition to, being directly displayed on the brand channel of the advertiser 102 in operation 5404.

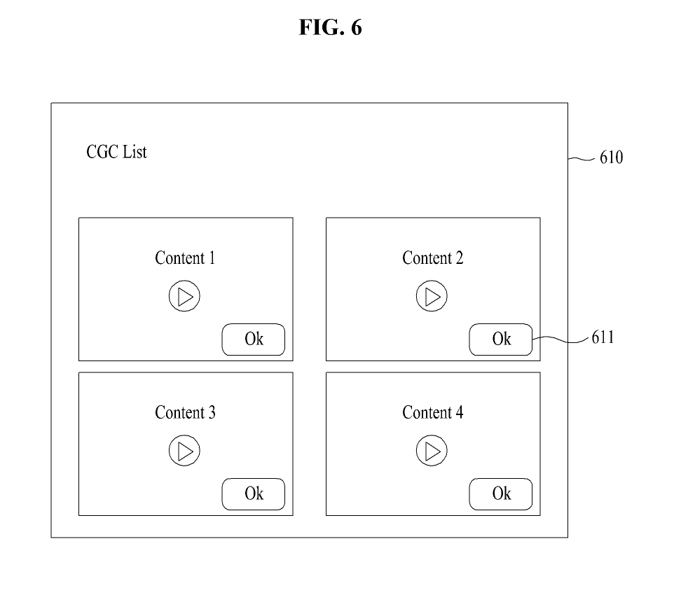

In operation 5405, the advertiser 102 verifies the brand channel registered by the creator 101 on the open commercial platform 100 and then approves content desired to be used for an actual viral purpose, that is, as a final advertisement of the advertiser 102 in operation 5405. For example, referring to FIG. 6, the advertiser 102 verifies a list of advertising contents 610 uploaded to the brand channel of the advertiser 102 within the open commercial platform 100 and then checks and approves an “ok” box 611 of content desired to be used as a viral purpose from the list of advertising contents 610. When the “ok” box has not been checked, approval of the content has not been granted. Other methods of indicating advertiser approval (or dis-approval) of the various contents are also contemplated.

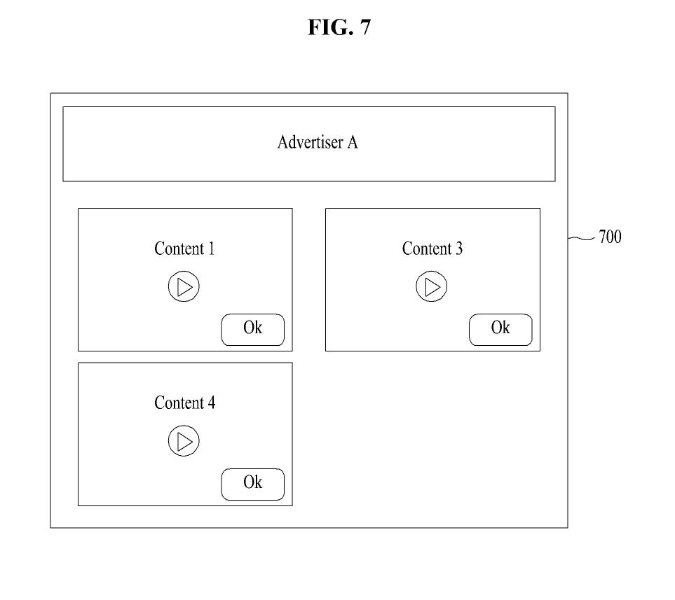

In operation S406, the open commercial platform 100 makes a determination of whether the content has been approved, and then provides only the advertising content that has been approved by the advertiser 102 for the actual viral purpose as a display target of the brand channel, instead of displaying all of the advertising content uploaded by the creator 101 to the brand channel of the advertiser 102. Referring to FIG. 7, in an example in which contents 1, 2, 3, and 4 are uploaded to the brand channel of the advertiser A and the advertiser A has approved the contents 1, 3, and 4, only the contents 1, 3, and 4 that have been approved by the advertiser A are displayed on a service page 700 of the advertiser A that is serviced (provided) to the users, including the creator 101.

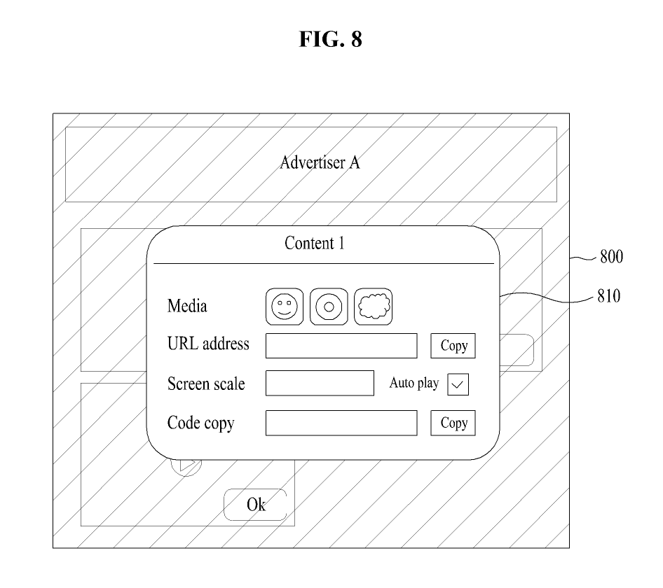

In operation 407, the open commercial platform 100 may provide a service so that the advertising content displayed on the brand channel of the advertiser 102 may be shared among users in a viral manner within the open commercial platform 100 or through external display media. In particular, the advertising content displayed on the brand channel of the advertiser 102 may be shared through an SNS, a blog, a café, etc. Referring to FIG. 8, in an example in which contents 1, 3, and 4 are displayed on a service page 800 of the advertiser A and a user has selected the content 1 from among the contents 1, 3, and 4, a popup screen 810 including a sharing function may be displayed. The user may share the selected content 1 in a viral manner by arbitrarily setting display media or the like through the popup screen 810.

With respect to the advertising content displayed on the brand channel of the advertiser 102, the open commercial platform 100 performs settlement, for example, charges the advertising cost in operation S408 and distributes the profit in operation S409 based on the performance occurring within the open commercial platform 100 and the performance occurring in the other display media through sharing. In response to the occurrence of the viral performance associated with the advertising content approved by the advertiser 102, the advertiser 102 may pay the advertising cost according to the viral performance. Accordingly, the open commercial platform 100 may distribute a portion of advertising profit associated with the approved advertising content to the creator 101 that generated the advertising content.

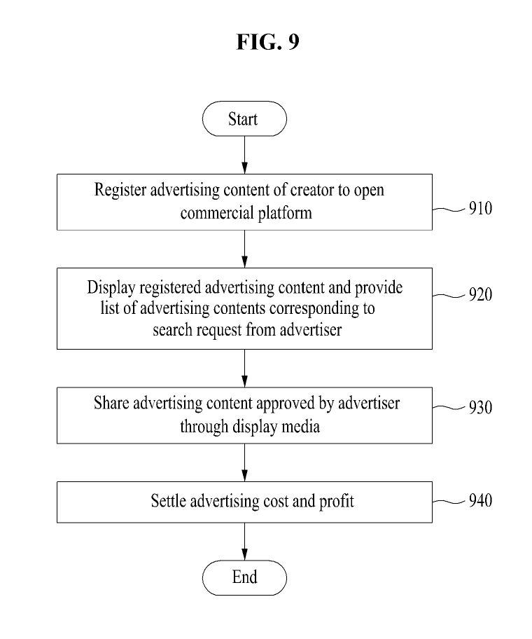

FIG. 9 is a flowchart illustrating another example of an advertising providing method using an open commercial platform according to an exemplary embodiment.

In operation 910, the registerer 212 may register advertising content generated by a creator to an open commercial platform. When the advertising content is registered, information about an advertiser, a related tag or a category such as a type of business, etc. may be registered together or simultaneously for the content classification or search convenience of the advertiser. In other words, the creator may readily register the generated advertising content, and during a process of registering the advertising content, the creator may input information about an advertiser or may set a related tag or a category such as a type of business, etc., for the content classification or search convenience of the advertiser.

In operation 920, the provider 213 may display the advertising content at the same time at which the advertising content is registered, and may open the advertising content registered by the creator to all of the users connecting to the open commercial platform. Here, for user convenience, the provider 213 may classify and display the registered advertising content based on advertiser information, the tag, and the category set by the creator, etc. In particular, the provider 213 may provide a search function for advertising content registered to the open commercial platform, and may extract and provide a list of contents corresponding to a search request from the advertiser through the search function. For example, the advertiser may search for advertising content suitable for a utilization purpose from among advertising contents registered to the open commercial platform using a variety of content search methods such as keyword tagging, a subtitle search, etc., provided from a platform operator. Here, the advertising content suitable for the utilization purpose may be associated or unassociated with a company of the advertiser.

Although the present exemplary embodiments limit a display target to be serviced to a user and a search target corresponding to a request from an advertiser to advertising contents registered to the open commercial platform, the exemplary embodiments are not limited thereto. The provider 213 may provide a service to all of externally open advertising contents in interaction with another external platform or display media. That is, regardless of a platform or display media, and without limiting the display target and the search target to a specific platform, all of the advertising contents may be included as a target.

When the advertiser searches for advertising content to be used for a viral purpose and finally approves the found advertising content, the provider 213 may display the specific advertising content approved by the advertiser in association with the advertiser. For example, the provider 213 may classify and display advertising content approved by an advertiser for each advertiser. Additionally, when displaying the approved advertising content, the provider 213 may display information about the advertiser that has approved the advertising content. As another example, when a brand channel of the advertiser is generated through the generator 211, the provider 213 may display advertising content approved by the advertiser through the brand channel of the advertiser.

When advertising content registered by the creator is universal content that does not expose a specific company, brand, product, etc., the open commercial platform may be configured so that an advertiser that has initially approved the advertising content may preoccupy the corresponding content as viral content, or may be configured to select a final advertiser for the corresponding content by recruiting advertisers having interest in the corresponding content during a preset period of time, for example, 24 hours, and by applying a bidding method.

In operation 930, the sharer 214 may share the advertising content approved by the advertiser for the viral purpose with display media in response to a user request. Here, the sharer 214 may provide a sharing function through an SNS, a blog, a café, a messenger service, a mail service, a message service, etc., so that a user may readily utilize advertising content approved by a specific advertiser in a viral manner.

Operation 940 of settling advertising cost and profit based on the viral performance of advertising content is the same as the aforementioned operation 350 of FIG. 3 and thus, a further description will be omitted.

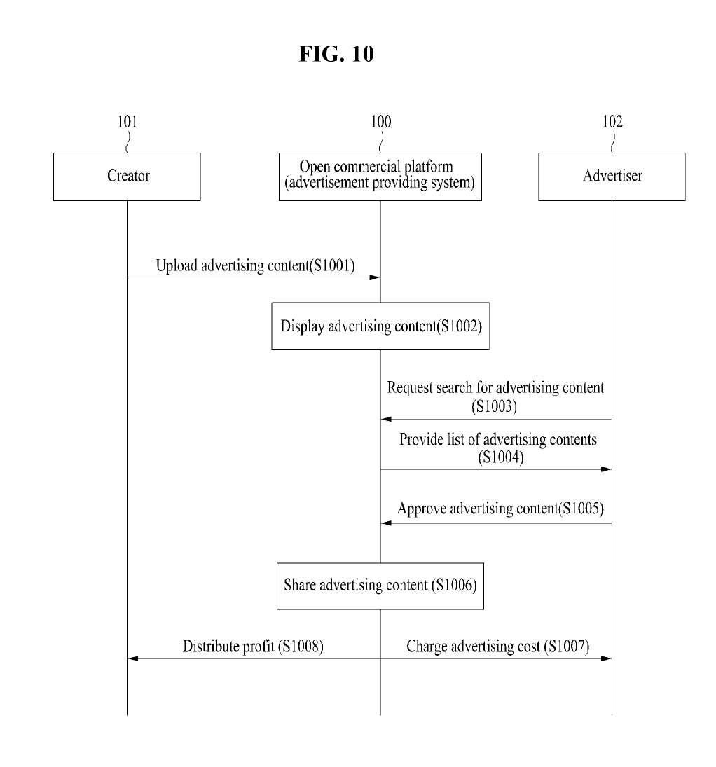

FIG. 10 illustrates a service flow according to the advertisement providing method of FIG. 9.

Referring to FIG. 10, in operation S1001, a creator 101 uploads advertising content generated by the creator 101 to an open commercial platform 100. Here, the open commercial platform 100 may correspond to the advertisement providing system 100 of FIG. 1. The creator 101 may specify an advertiser 102 or set a related tag or a category such as a type of business, etc., and may readily register the advertising content to the open commercial platform 100.

In operation S1002, once the creator 101 uploads the advertising content, the open commercial platform 100 may display the advertising content uploaded by the creator 101 so that users may view the uploaded advertising content.

In operation S1003, the advertiser 102 may make a search request for advertising content through a content search method, for example, keyword tagging, a subtitle search, etc., provided from the open commercial platform 100. In operation S1004, the open commercial platform 100 may provide a list of advertising contents corresponding to the search request from the advertiser 102. Here, a search target may include all advertising contents open through another external platform or display media in addition to the advertising contents registered to the open commercial platform 100.

In operation S1005, the advertiser 102 searches for advertising content suitable for a utilization purpose from among advertising contents registered by the creators 101, and selectively approves any advertising content desired to be used for an actual viral purpose. Here, the open commercial platform 100 may classify and thereby display the advertising content that has been approved by the advertiser 102 as an advertisement of the advertiser 102, or may also display information about the advertiser 102. Additionally, if an exclusive brand channel of the advertiser 102 has been generated, the open commercial platform 100 may display the advertising content approved by the advertiser 102 through the brand channel of the advertiser 102.

The open commercial platform 100 may provide a service so that the advertising content approved by the advertiser 102 may be shared among users in a viral manner within the open commercial platform 100 or through external display media. In particular, in response to a user request, the open commercial platform 100 may share the advertising content approved by the advertiser 102 through an SNS, a blog, a café, etc. in operation S1006.

The open commercial platform 100 performs settlement, such as for example, charging the advertising cost in operation S1007 and distributing profit in operation S1008 based on the performance occurring within the open commercial platform 100 and the performance occurring via display media through sharing, with respect to the advertising content displayed on the brand channel of the advertiser 102. In response to the occurrence of the viral performance associated with the advertising content approved by the advertiser 102, the advertiser 102 may pay the advertising cost according to the viral performance. In certain embodiments, the open commercial platform 100 may distribute a portion of profit associated with the advertising content that was approved by the advertiser 102 to the creator 101 having created the advertising content.

According to some exemplary embodiments, a consumer may directly generate content, and may provide the generated content as an advertisement of a company. An advertisement generated by the consumer may be operated to be viral to earned media. Further, in some embodiments, profit according to the advertising effect may be shared with the consumer.

The advertisement providing method may include a further reduced number of operations or additional operations based on the description made above with reference to FIGS. 1 through 10. Also, at least two operations may be combined and the order or location of the operations may be modified.

Service screens of FIGS. 5 through 8 are provided as examples to help in the understanding of the disclosure and thus, the present disclosure is not limited to the exemplary embodiments and the configuration or the order of a screen may be readily modified.

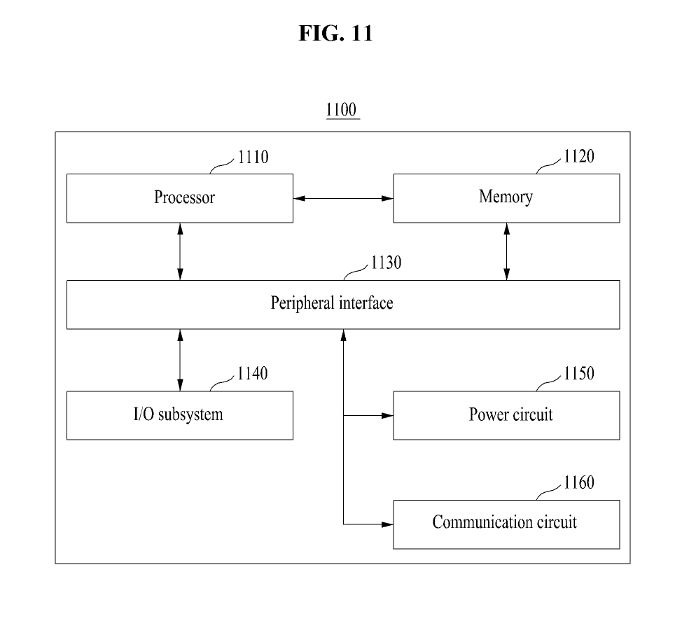

FIG. 11 is a block diagram illustrating an example of a configuration of a computer system 1100 according to an exemplary embodiment.

Referring to FIG. 11, the computer system 1100 may include at least one processor 1110, a memory 1120, a peripheral interface 1130, an input/output (I/O) subsystem 1140, a power circuit 1150, and a communication circuit 1160. Here, the computer system 1100 may correspond to a user terminal used by a creator or an advertiser.

The memory 1120 may include, for example, a high-speed random access memory (HSRAM), a magnetic disk, a static random access memory (SRAM), a dynamic RAM (DRAM), read only memory (ROM), a flash memory, a non-volatile memory, etc. The memory 1120 may include a software module, a computer readable instruction set, and/or a variety of data required for an operation of the computer system 1100. Here, access from another component such as the processor 1110 and the peripheral interface 1130 to the memory 1120 may be controlled by the processor 1110.

The peripheral interface 1130 may couple an input device and/or output device of the computer system 1100 with the processor 1110 and the memory 1120. The processor 1110 may perform a variety of functions for the computer system 1100 and process data by executing the software module or the instruction set stored in the memory 1120.

The I/O subsystem 1140 may couple various I/O peripheral devices with the peripheral interface 1130. For example, the I/O subsystem 1140 may include a controller for coupling the peripheral interface 1130 and a peripheral device such as a monitor, a keyboard, a mouse, a printer, and a touch screen or a sensor depending on a necessity. The I/O peripheral devices may be coupled with the peripheral interface 1130 without using the I/O subsystem 1140.

The power circuit 1150 may supply a power to all of or a portion of components of a terminal. For example, the power circuit 1150 may include a power management system, at least one power source such as a battery and alternating circuit (AC), a charge system, a power failure detection circuit, a power converter or inverter, a power status indicator, or other components for creating, managing and distributing power.

The communication circuit 1160 enables communication with another computer system using at least one external port. Additionally, as described above, the communication circuit 1160 may enable communication with another computer system by including a radio frequency (RF) circuit and thereby transmitting and receiving an RF signal known as an electromagnetic signal.

The exemplary embodiments of FIG. 11 are only examples of the computer system 1100. The computer system 1100 may have a configuration or an arrangement that omits some of the components illustrated in FIG. 11, or it may further include additional components that are not illustrated in FIG. 11, or it may involve coupling two or more components together. For example, a computer system for a communication terminal of a mobile environment may further include a touch screen, a sensor, and the like, in addition to the components of FIG. 11. A circuit for RF communication using a variety of communication methods, for example, wireless fidelity (Wi-Fi), 3rd generation (3G), long term evolution (LTE), Bluetooth, near field communication (NFC), and ZigBee, may be included in the communication circuit 1160. Components includable in the computer system 1100 may be configured as hardware that includes an integrated circuit specified for at least one signal processing or application (e.g., ASIC), software, or a combination of hardware and software.

The methods according to the exemplary embodiments may be configured in a program instruction form executable through various computer systems and thereby recorded in non-transitory computer-readable media. A program according to the exemplary embodiments may be configured as a PC-based program or an application exclusive for a mobile terminal. An application may be installed in the user terminal through a file provided from a file distribution system. As an example, the file distribution system may include a file transmitter (not shown) to transmit the file in response to a request from the user terminal.

According to some exemplary embodiments, it is possible to configure a new advertisement model that enables a consumer that has generated content and an advertiser to mutually develop by circulating the consumer generated content as an advertisement of a company through an open commercial platform. On the consumer side, since the consumer may directly generate the advertisement of the company and may share the profit according to the advertising effect, it is possible to induce the consumer to take the initiative to generate content and provide the content in a viral manner. On the advertiser side, since an advertiser may utilize lean forward advertising in which an advertisement itself instead of an advertisement disguised as content is content, it is possible to maximize the advertising effect. Also, on the advertising company side, the advertising company may secure a variety of advertising contents from many consumers and may also secure media competitiveness by providing a further friendly advertisement to a user. On the user side, the user may not have an antipathy against an advertisement of a company by consuming contents generated by consumers equivalent to the user instead of consuming typical one-sided and repetitive advertisements.

The exemplary embodiments as disclosed herein may comprise program code including program instructions, software components, software modules, data files, data structures, and/or the like that are implemented by one or more physical hardware devices. Examples of program code include both machine code produced by a compiler and higher level program code that is executed using an interpreter. The hardware devices may include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

Alternatively, or in addition to the processors discussed above, the hardware devices may include one or more Central Processing Units (CPUs), digital signal processors (DSPs), application-specific-integrated-circuits (ASICs), SoCs, field programmable gate arrays (FPGAs), or the like. In at least some cases, the one or more CPUs, SoCs, DSPs, ASICs and FPGAs, may generally be referred to as processing circuits and/or microprocessors.

The hardware devices may also include one or more storage devices. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the exemplary embodiments described herein. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the exemplary embodiments, or they may be known devices that are altered and/or modified for the purposes of the exemplary embodiments.

It will be apparent to those skilled in the art that various modifications and variations can be made in the exemplary embodiments without departing from the spirit or scope of the invention. Thus, it is intended that the exemplary embodiments cover the modifications and variations of this invention provided they come within the scope of the appended claims and their equivalents.

What is claimed is:

1. An advertisement providing method executed on a computer including at least one processor, the method comprising:
generating a service channel for each advertiser;
receiving content generated by a creator from a creator terminal and registering the received content; and
displaying specific content approved by an advertiser among contents as advertising content of the advertiser,
wherein the registering comprises registering the content to the service channel.

2. The method of claim 1, wherein the displaying comprises displaying specific content approved by the advertiser among contents registered to the service channel, through the service channel.

3. The method of claim 1, wherein the displaying comprises:
providing a list of contents corresponding to a search request from the advertiser among the registered contents; and
displaying specific content approved by the advertiser from the list of contents as the advertising content.

4. The method of claim 3, wherein the displaying comprises simultaneously registering and displaying the content and classifying the content based on information set by the creator and displaying the classified content.

5. The method of claim 1, wherein the displaying comprises:
providing a list of contents corresponding to a search request from the advertiser among the registered contents and public contents registered to an external platform or display media; and
displaying specific content approved by the advertiser from the list of contents as the advertising content.

6. The method of claim 1, wherein the displaying comprises displaying the specific content as advertising content of an advertiser that has previously approved the specific content.

7. The method of claim 1, wherein the displaying comprises displaying the specific content as advertising content of an advertiser selected through bidding.

8. The method of claim 1, further comprising:
sharing the advertising content through at least one display media.

9. The method of claim 8, wherein the sharing comprises sharing, in response to a user request, the advertising content through at least one of a social networking service (SNS), an Internet bulletin board, a messenger service, a mail service, and a message service selected by a user.

10. The method of claim 1, further comprising:
calculating advertising cost based on at least one of display counts of the advertising content, user view counts, and share counts, and charging the advertiser the calculated advertising cost.

11. The method of claim 1, further comprising:
distributing a portion of a profit earned in association with the advertising content to a creator having generated the specific content.

12. A non-transitory computer readable medium comprising computer readable instructions to control a computer system to provide an advertisement, wherein the computer readable instructions are configured to:
generate a service channel for each advertiser;
receive content generated by a creator from a creator terminal and register the received content to the service channel;
display specific content that has been approved by an advertiser among contents as advertising content of the advertiser; and
distribute a portion of a profit earned in association with the advertising content to a creator having generated the specific content.

13. An advertisement providing system comprising:
a generator configured to generate a service channel for each advertiser;
a registerer configured to receive content generated by a creator from a creator terminal and to register the received content; and
a provider configured to display specific content that has been approved by an advertiser among contents as advertising content of the advertiser,
wherein the registerer is further configured to register the content to the service channel.

14. The advertisement providing system of claim 13, wherein the provider is further configured to display specific content registered by the advertiser among contents registered to the service channel, through the service channel.

15. The advertisement providing system of claim 13, wherein the provider is further configured to provide a list of contents corresponding to a search request from the advertiser among the registered contents, and to display specific content approved by the advertiser from the list of contents as the advertising content.

16. The advertisement providing system of claim 13, wherein the provider is further configured to display the specific content as advertising content of an advertiser that has previously approved the specific content.

17. The advertisement providing system of claim 13, wherein the provider is further configured to display the specific content as advertising content of an advertiser selected through bidding.

18. The advertisement providing system of claim 13, further comprising:
a sharer configured to share, in response to a user request, the advertising content through at least one of a social networking service (SNS), an Internet bulletin board, a messenger service, a mail service, and a message service selected by a user.

19. The advertisement providing system of claim 13, further comprising:
a settler configured to calculate advertising cost based on at least one of display counts of the advertising content, user view counts, and share counts, and to charge the advertiser the calculated advertising cost.

20. The advertisement providing system of claim 13, further comprising:
a distributor configured to distribute a portion of profit earned in association with the advertising content to a creator that generated the specific content.
